(19) United States
(12) Patent Application Publication
(10) Pub. No.: US 2019/0164396 A1
(43) Pub. Date: May 30, 2019

(54) DISPLAY SYSTEM HAVING FUCNTION FOR DISPLAYING INSTRUCTION MARKS

(71) Applicant: KYOCERA Document Solutions Inc., Osaka (JP)

(72) Inventor: Shinji HAYASHI, Osaka (JP)

(73) Assignee: KYOCERA Document Solutions Inc., Osaka (JP)

(21) Appl. No.: 16/201,503

(22) Filed: Nov. 27, 2018

(30) Foreign Application Priority Data
Nov. 27, 2017 (JP) 2017-226660

(51) Int. Cl. G08B 7/06; G06T 7/70; G06T 7/20; G06Q 10/08

(52) U.S. Cl. CPC G08B 7/066; G06T 7/70; G06T 7/20; G06T 2207/30196; G06T 2207/30241; G06T 2207/30204; G06Q 10/087

(57) ABSTRACT

Provided is a technique that, in the case of causing an instruction mark to be displayed on a floor, is able to appropriately display the instruction mark while taking into consideration people and other obstacles (shielding objects). A display system includes a plurality of curved mirrors, a laser pointer, a monitoring camera, an output-control unit, and a person-movement-determining unit. The plurality of curved mirrors is installed on a ceiling. The laser pointer outputs a nudge to be displayed on the floor. The monitoring camera captures an image of an area where the nudge is displayed. The output-control unit controls the output of the nudge. The person-movement-determining unit, based on an image captured by the monitoring camera, determines an output direction in which to output the nudge. The nudge that is outputted from the laser pointer is reflected by a curved mirror and displayed at a nudge-display position.

### INCORPORATION BY REFERENCE

This application is based on and claims the benefit of priority from Japanese Patent Application No. 2017-226660 filed on Nov. 27, 2017, the contents of which are hereby incorporated by reference.

### BACKGROUND

The present disclosure relates to a display system, for example, a display system having a function for displaying instruction marks (also referred to as “display marks”) indicating a traveling direction or a stop position with respect to pedestrians or the like.

There are known apparatuses for giving instructions related to locations of lines and traveling directions in the case where people are lined up at a checkout place (for example, a cash register) at a shop or when entering a building. For example, in the case where there are a large number of cash registers in a shop, a system indicating the location of a vacant cash register has been introduced to realize smooth guidance of customers.

As a typical technique, for example, when entering a building where security authentication is performed, there is a technique of providing instructions/guidance to pedestrians to be authenticated to improve authentication accuracy and trying to smooth guidance. More specifically, the walking state of a pedestrian is estimated, and the walking instructions (instruction marks) are sequentially displayed on the floor or the road by a projecting apparatus.

### SUMMARY

The display system according to the present disclosure includes a plurality of reflecting units, an image-projecting unit, an imaging unit, an output-control unit, and an output-direction-determining unit. The plurality reflecting units is installed on a ceiling. The image-projecting unit outputs an instruction mark to be displayed on a floor. The imaging unit captures an image of an area where the instruction mark is displayed. The output-control unit controls the output of the instruction mark. The output-direction-determining unit, based on an image captured by the imaging unit, determines an output direction in which to output the instruction mark. The instruction mark that is outputted from the image-projecting unit is reflected by the reflecting unit and displayed at a mark-display position.

### BRIEF DESCRIPTION OF THE DRAWINGS

FIG. 1A is a diagram illustrating a state in which a display system is installed according to an embodiment.

FIG. 1B is a diagram illustrating a state in which a display system is installed according to an embodiment.

FIG. 2A is a diagram illustrating a state in which a nudge is projected on a floor by a display system according to an embodiment.

FIG. 2B is a diagram illustrating a state in which a nudge is projected on a floor by a display system according to an embodiment.

FIG. 3 is a block diagram illustrating a schematic configuration of a display system according to an embodiment.

FIG. 4 is a diagram for explaining a display switching process of a nudge projected on a floor according to an embodiment.

FIG. 5 is a flowchart illustrating a nudge projection process by a display system according to an embodiment.

### DETAILED DESCRIPTION

Hereinafter, a mode (hereinafter referred to as an “embodiment”) for implementing the technique according to the present disclosure will be described with reference to the drawings.

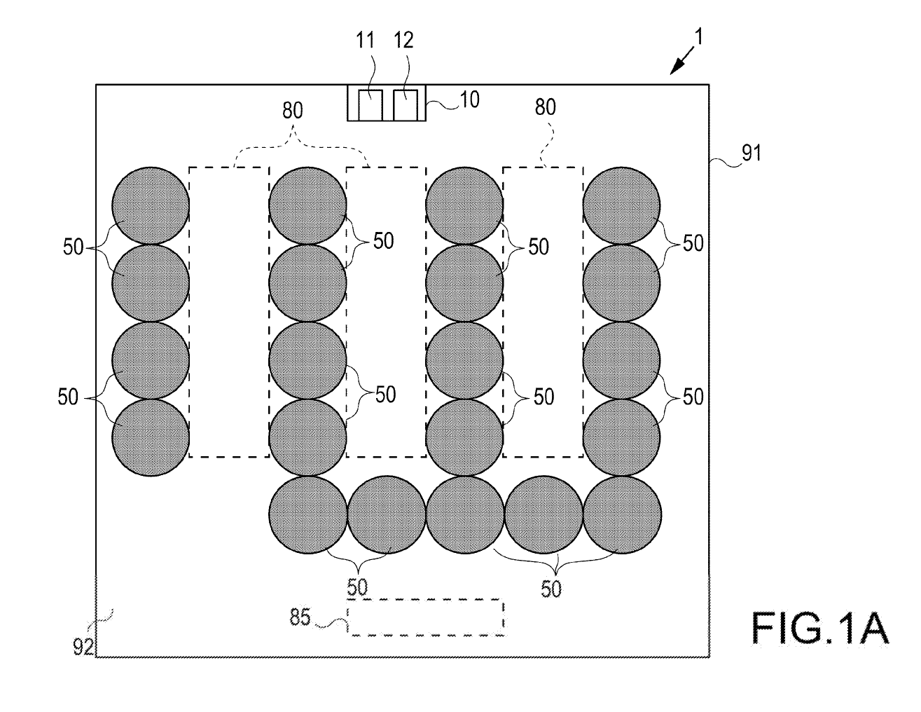

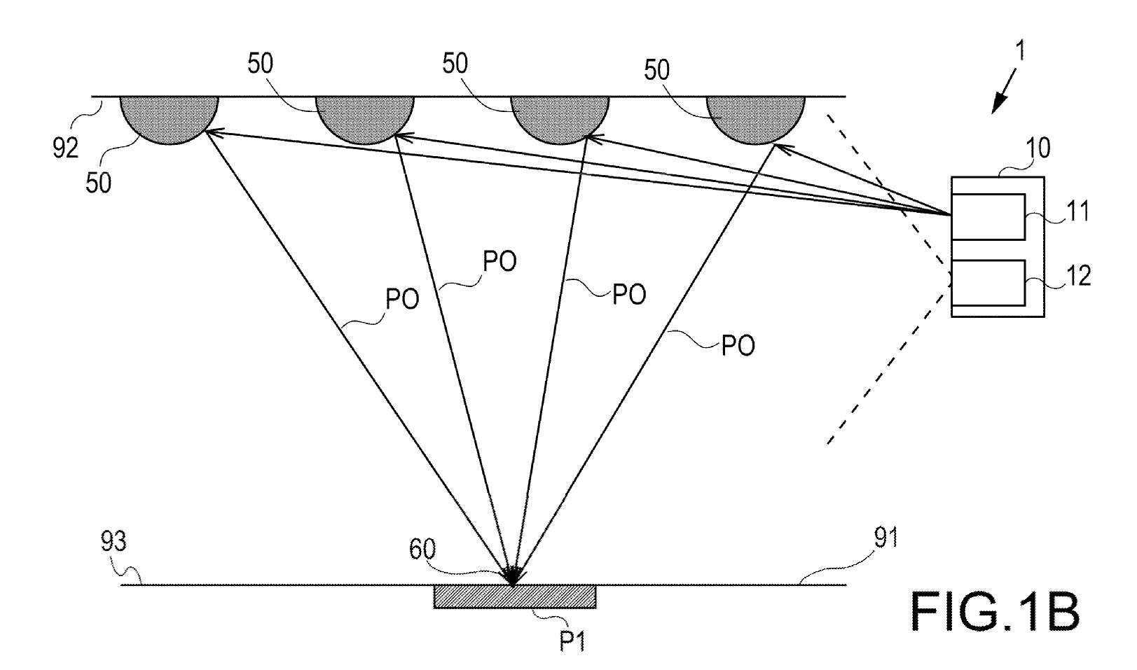

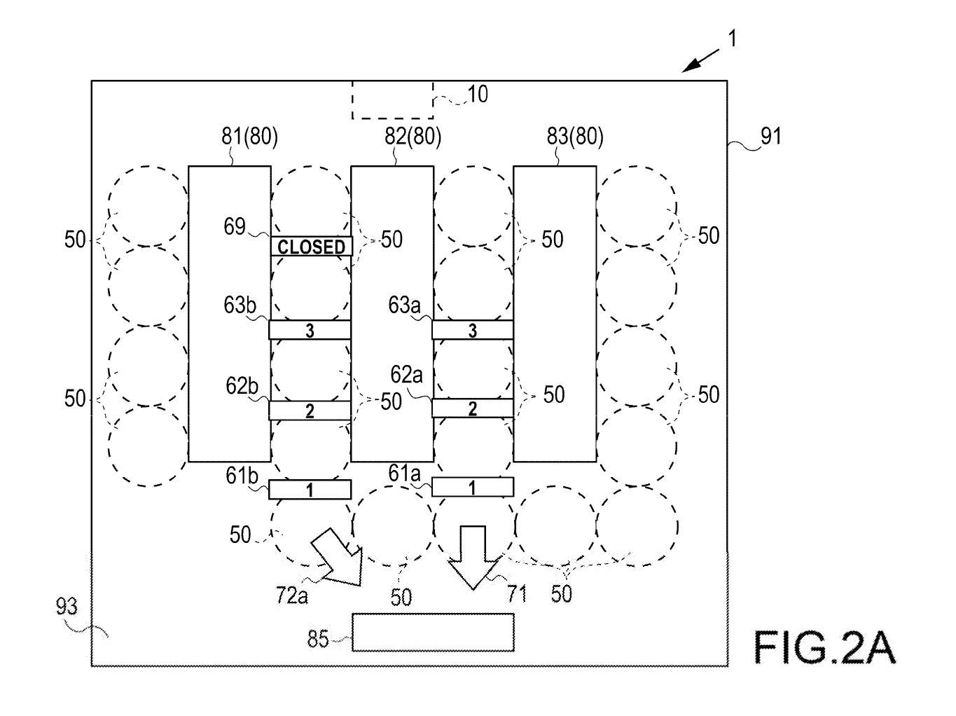

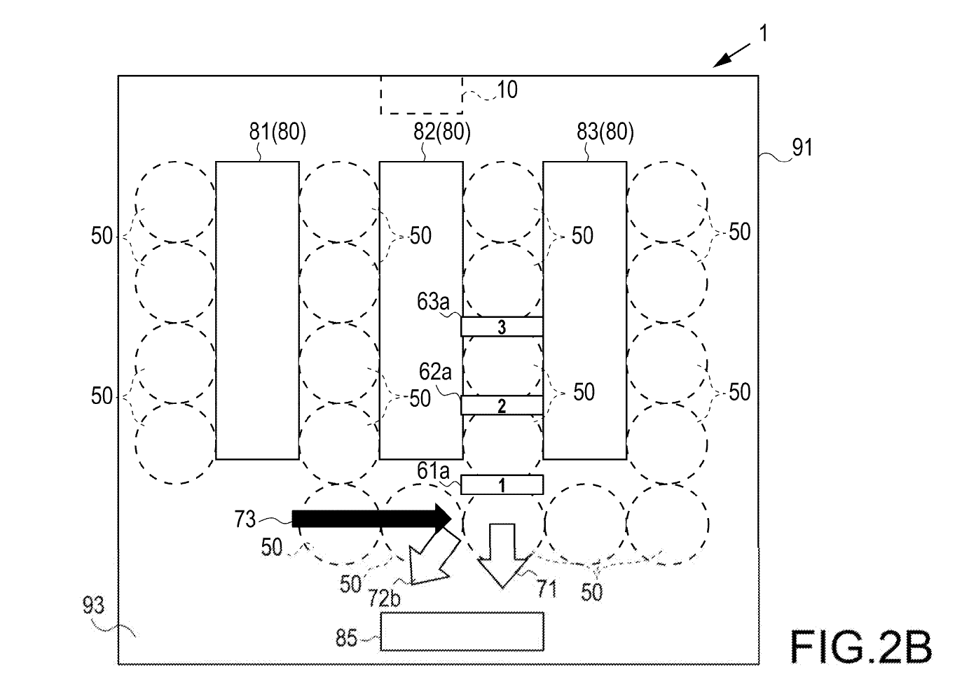

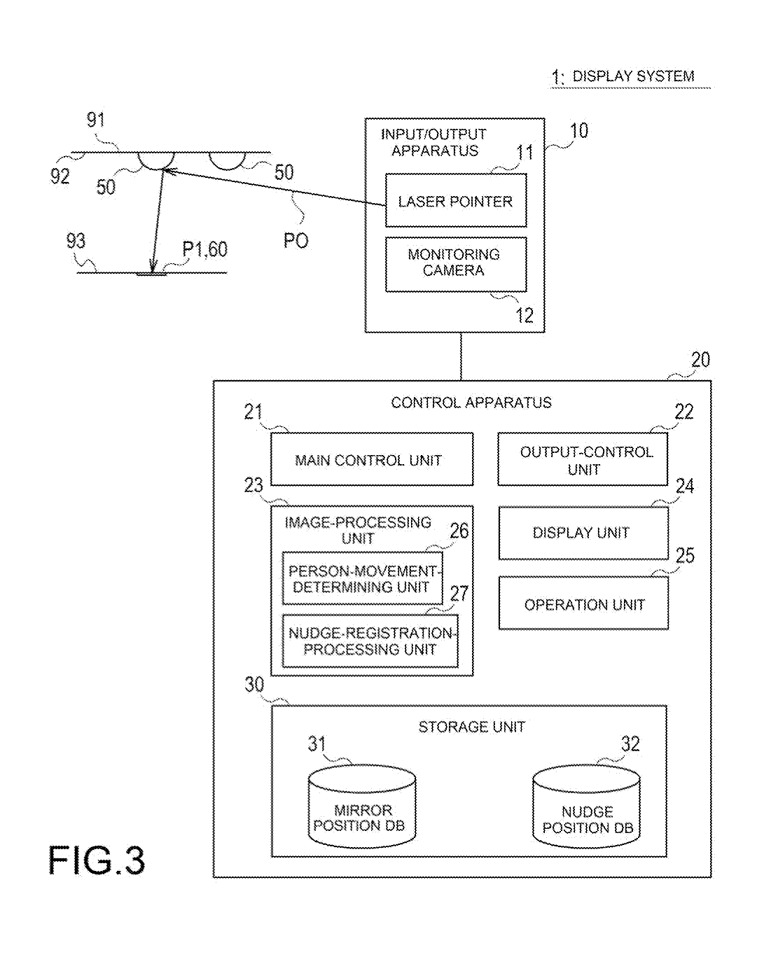

The outline of this embodiment will be described with reference to FIGS. 1A to 3. FIG. 1A and FIG. 1B illustrate a state in which a display system 1 is installed in a shop 91 or the like. FIG. 1A is a plan view of the installation location, and FIG. 1B is a side view. FIG. 2A and FIG. 2B illustrate specific examples of instruction marks (hereinafter referred to as “nudges 60”) displayed on a floor 93. FIG. 3 is a block diagram schematically illustrating the configuration of the display system 1.

As illustrated in FIG. 1A to FIG. 2B, the display system 1 includes a plurality of curved mirrors 50 (reflecting units) installed on a ceiling 92 and an input/output apparatus 10. In addition, as illustrated in FIG. 3, the display system 1 includes a control apparatus 20 for controlling the input/output apparatus 10.

Inside the shop 91, three vertical rows of shelves 80 (shelves A 81 to shelves C 83) are arranged in FIG. 2A and FIG. 2B, and a table 85 is arranged in front thereof (lower side in FIG. 2A and FIG. 2B). Here, it is presumed that people line up in spaces between the shelves 80 and move toward the table 85. The curved mirrors 50 are not arranged in the upper portions of the shelves 80 but are arranged on the ceiling 92 above the positions where the shelves 80 are arranged and the adjacent positions adjacent on the left and right. The nudges 60 are not displayed at the installation positions of the shelves 80, and are omitted from the aspect of efficiency. Needless to say, the curved mirrors 50 may be arranged on the entire surface of the ceiling 92.

The input/output apparatus 10 includes a laser pointer 11 and a monitoring camera 12. From the aspect of avoiding obstacles, the input/output apparatus 10 is preferably arranged at a relatively high place, for example, at a position higher than a person's height or installed objects such as the shelves 80. Moreover, the laser pointer 11 and the monitoring camera 12 may be installed at different positions. Furthermore, there may be a plurality of laser pointers 11 and monitoring cameras 12, respectively. By increasing the number of monitoring cameras 12, it is possible to improve the detection accuracy of obstacles and the confirmation accuracy of the optical path PO.

A laser pointer 11 projects an image toward a curved mirror 50 and causes a nudge 60 as an instruction mark to be reflected by the curved mirror 50 and displayed on the floor 93. An image outputted from the laser pointer 11 is reflected by the curved mirror 50 and displayed as a nudge 60 at a nudge display position P1. At this time, an appropriate optical path PO capable of avoiding the shelves 80 of the shop 91 and people, or in other words, an appropriate curved mirror 50 is selected as the projection direction.

The output mode of the laser pointer 11 may be monochrome or multiple colors. In addition, the output may be a still image or a moving image. In the case of a line, the line may be a solid line or a broken line. Also, the output may be made to flash or the like. In any case, the output is outputted in a manner that is easy for people to perceive.

The monitoring camera 12 captures images of the movement of people and the displayed nudges 60 in the shop 91 so that the nudges 60 can be properly displayed in the specific nudge-display position P1.

Here, in the example of FIG. 2A, the nudge 60 is displayed in the space between the shelves A 81 and the shelves B 82 and the space between the shelves B 82 and the shelves C 83. More specifically, in the space between the shelves B 82 and the shelves C 83, starting from a slightly forward position from the end of the shelves B 82 (shelves C 83), at specific intervals going backward, a nudge “1” 61a, a nudge “2” 62a, and a nudge “3” 63a are displayed. Nudge “1” 61a includes the number 1 inside a rectangle. Nudge “2” 62a includes the number 2 inside a rectangle. Nudge “3” 63a includes the number 3 inside a rectangle. Furthermore, in front of the nudge “1” 61a, a forward pointing arrow 71 instructing to move toward the table 85 is displayed.

Moreover, in the space between the shelves A 81 and the shelves B 82, starting from a slightly forward position from the end of the shelves A 81 (shelves B 82), at specific intervals going backward, a nudge “1” 61b, a nudge “2” 62b, a nudge “3” 63b, and a “Closed Nudge” 69 are displayed. Nudge “1” 61b includes the number 1 inside a rectangle. Nudge “2” 62b includes the number 2 inside a rectangle. Nudge “3” 63b includes the number 3 inside a rectangle. The “Closed Nudge” 69 includes the English word CLOSED inside a rectangle. Furthermore, in front of the nudge “1” 61b, a diagonally pointing arrow 72a instructing to move toward the table 85 is displayed. Numbers indicate the order from the beginning of the row, and English words indicate the content that the displayed Nudge 60 wants to convey to people. Here, nudge 60 is the Closed nudge 69. Here, the content to be conveyed is content to the effect that the row is closed and not to line up. In the case where the Closed nudge 69 is displayed, the administrator or the like of the shop 91 may physically close the row after a specific amount of time.

In the example of FIG. 2B, nudges 60 (nudge “1” 61a to nudge “3” 63a) are displayed in the space between the shelves B 82 and the shelves C 83. Furthermore, in front of the nudge “1” 61a, a forward pointing arrow 71 and a diagonally pointing arrow 72b are displayed giving an instruction to move to the table 85.

Here, in the case where a person moves in a traverse direction in the space between the shelves 80 and the table 85 (the direction of the arrow 73), the nudges 60 of the forward arrow 71 and the diagonal arrow 72b disappear. Therefore, by determining the situation in advance and switching the optical path PO, it is possible to prevent the disappearance of the nudges 60 from the floor 93. In addition, in the case where a person stops at the nudge-display position P1, the nudge 60 is turned OFF or only the portion that is not shadowed by a person is displayed. In other words, the display system 1 changes the display mode of the nudge 60 according to the movement and position of the people.

Continuing, the control apparatus 20 for controlling the display output of the display system 1 will be described with reference to FIG. 3. The control apparatus 20 includes a main-control unit 21, an output-control unit 22, an image-processing unit 23, a display unit 24, and an operation unit 25.

The main-control unit 21 performs overall control of each element of the control apparatus 20. The output-control unit 22 controls the operation of the laser pointer 11. More specifically, the output-control unit 22 selects the nudge 60 that is displayed on the floor 93, the position where the nudge 60 is displayed (in other words, the nudge-display position P1), and the curved mirror 50 that reflects an image (in other words, the optical path PO).

The image-processing unit 23 acquires the image captured by the monitoring camera 12 and controls the image output toward the curved mirror 50. More specifically, the image-processing unit 23 includes a person-movement-determining unit 26 and a nudge-registration-processing unit 27.

The person-movement-determining unit 26 discerns the movement of a person in an image based on images captured by the monitoring camera 12, and determines the traveling direction, the stop position, the presence or absence of an obstacle, and the like, and notifies the output-control unit 22. Here, as an example of the method of determination, a case in which the laser pointer 11 and the monitoring camera 12 are arranged at the same location will be explained. In this case, there is (1) a method of determining whether an obstacle is present depending on whether or not a prerecorded floor 93 pattern is read, and (2) a method of determining whether or not the displayed nudge 60 can be read. Upon receiving the notification of the determination result, the output control unit 22 controls the emission operation of the laser pointer 11 as described above.

The nudge-registration-processing unit 27 registers and records the nudge 60 to be displayed in the nudge-display position P1. More specifically, the nudge-registration-processing unit 27 registers what nudge 60 is to be displayed by which curved mirror 50 (in other words, the optical path PO) at which position on the floor 93. In the case where a plurality of optical paths PO can be used for one nudge-display position P1, priority is set and registered.

Moreover, in the case where the nudge 60 to be displayed on the floor 93 is not a “point” image but an image or a specific shape, it is necessary to perform correction of the outputted image since it passes through the curved mirror 50. In other words, the output-control unit 22 outputs a corrected output image from the laser pointer 11 that has been corrected in advance assuming the display on the floor 93 so that the nudge 60 is properly displayed in a desired shape on the floor 93. Therefore, when setting up the display system 1, an image that is the same as the nudge 60 to be displayed at the nudge-display position P1 of the floor 93 is placed at that position. Then, the nudge-registration-processing unit 27 determines how to correct the image, or in other words, determines what kind of image to output based on the image of the monitoring camera 12, and registers the image in a nudge DB 32 of a recording unit 30. When performing this registration, the nudge 60 to be displayed, the image to be outputted, and the output direction are correlated. The output direction may be correlated with a curved mirror 50 that reflects the image. In the case of configuration in which the optimum optical path PO is selected from a plurality of optical paths PO as described above, each optical path PO is registered.

The recording unit 30 includes a mirror DB 31 and a nudge DB 32.

The mirror DB 31 registers the position of the curved mirror 50 installed on the ceiling 92 in three-dimensional coordinates. The coordinates may be position coordinates. The coordinates may also be coordinates indicating direction. The coordinates are set, for example, with the installation position of the laser pointer 11 (image output position) as the origin. As described above, the nudge DB 32 stores the nudge 60 to be displayed that is correlated with the nudge-display position P1, the optical path PO, and the output image.

The display unit 24 displays the imaging target area captured by the monitoring camera 12. Here, the imaging target area may be inside the shop 91. The operation unit 25 receives a user operation for the display system 1, for example, switching of a nudge 60 to be displayed.

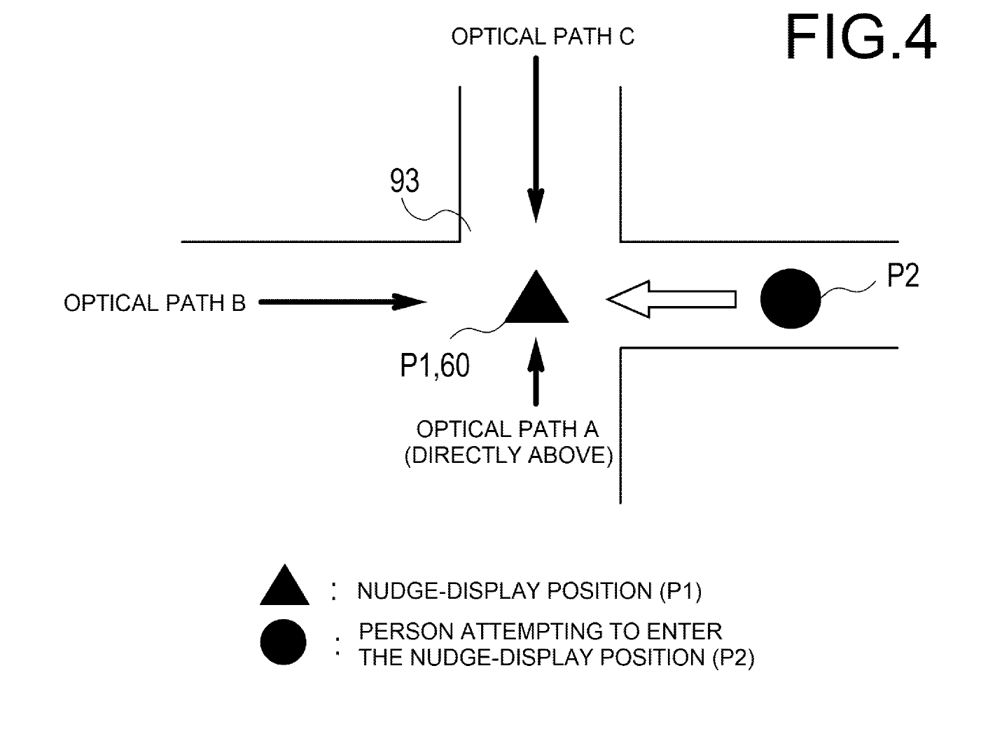

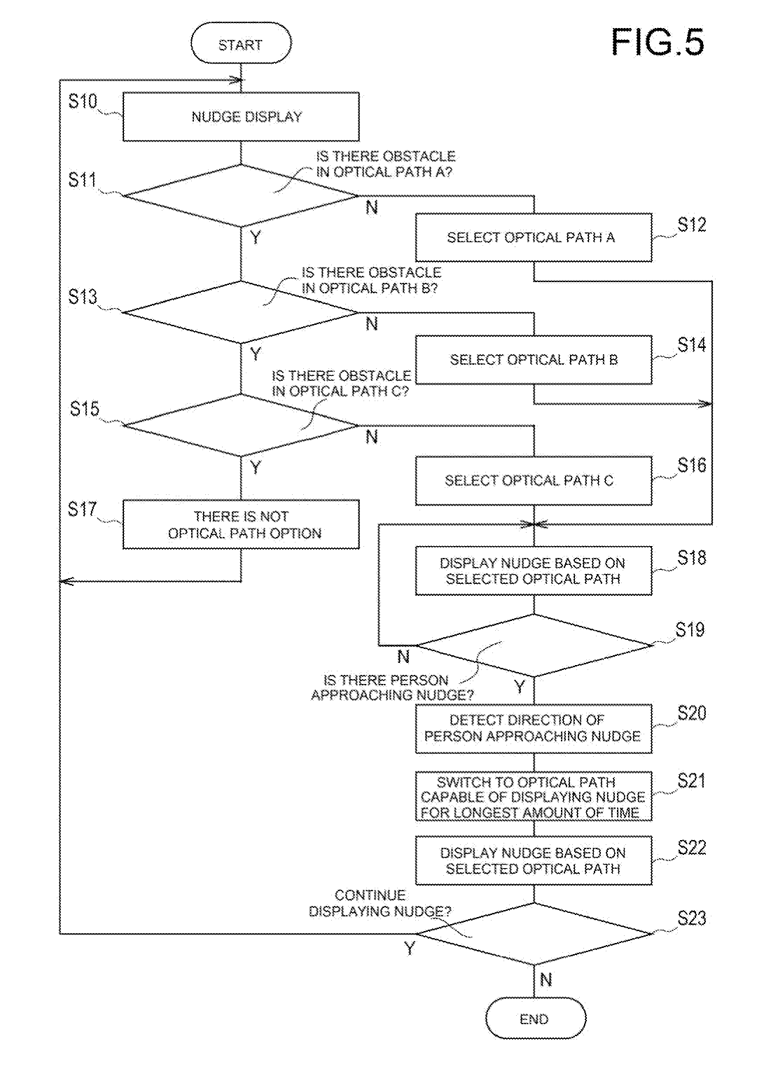

An operation example of the display system 1 having the above-described configuration will be explained with reference to the condition diagram in FIG. 4 and the flowchart in FIG. 5. It is presumed that there is one each of the laser pointer 11 and the monitoring camera 12. In addition, as illustrated in FIG. 4, there are three types of optical paths PO: optical path A, optical path B, and optical path C. The optical path A projects onto the floor 93 from directly above of a nudge-display position P1 (nudge 60), that is, vertically. The optical path B projects from left to right in FIG. 4. The optical path C projects from the top to the bottom in FIG. 4. The person P2 moves from the right to the left toward the nudge display position P1. As the order of selecting optical paths, the vertical incident optical path A has the highest priority, then optical path B, and finally optical path C. Here, the priority is set higher for an optical path PO with a projection angle that is closer to being vertical, however the priority setting is not limited to this, and for example, the optical path capable of displaying the nudge 60 in the same optical path PO for the longest time from the start of movement of the person P2 may be selected.

When the nudge 60 is displayed on the floor 93 by the laser pointer 11 (S10), the person-movement-determining unit 26 determines whether or not there is an obstacle in the optical path A on the basis of the image of the monitoring camera 12 and from the situation of the person P2 and other obstacles (S11). When it is determined that there is no obstacle (S11: NO), the person-movement-determining unit 26 selects the optical path A (S12).

In the case where it is determined that there is an obstacle in the optical path A (S11: YES), the person-movement-determining unit 26 determines whether or not there is an obstacle in the optical path B (S13). In the case where it is determined that there is no obstacle (S13: NO), the person-movement-determining unit 26 selects the optical path B (S14).

In the case where it is determined that there is an obstacle in the optical path B (S13: YES), the person-movement-determining unit 26 determines whether or not there is an obstacle in the optical path C (S15). In the case where it is determined that there is no obstacle (S15: NO), the person-movement-determining unit 26 selects the optical path C (S16).

In the case where it is determined that there is an obstacle in the optical path C (S15: YES), the person-movement-determining unit 26 determines that there is no optical path option and returns to the process of S10 (S17). At this time, the nudge 60 may be displayed as is or the nudge 60 may be removed.

After the optical path has been selected (S12, S14, S16), the output-control unit 22 acquires a notification regarding the selected optical path PO from the person-movement-determining unit 26, and then based on the optical path PO, outputs an image from the laser pointer 11, causing the nudge 60 to be displayed on the floor 93 (S18).

Continuing, the output-control unit 22 monitors the image captured by the monitoring camera 12 and determines whether there is a person P2 approaching the nudge display position P1 (S19). In the case where it is determined that there is no approaching person P2 (S19: NO), the display of the nudge 60 is left as it is (S18), and the output-control unit 22 continues monitoring (S19).

In the case where it is determined that there is an approaching person P2 (S19: YES), the person-movement-determining unit 26 detects the direction of movement of the person P2 (S20), and switches to the optical path PO capable of displaying the nudge 60 for the longest time on the same optical path PO (S21). The output-control unit 22 causes the nudge 60 to be displayed by controlling the laser pointer 11 based on the optical path PO selected as the optical path to switch to (S22).

Then, in the case where the display of the nudge 60 is to be continued (S23: YES), the process returns to S10, and when the display is not to be continued (S23: NO), the operation according to this flow ends.

Here, the main features of the above-described embodiment are summarized as follows.

(1) The display system according to this embodiment includes: a plurality of curved mirrors 50 (reflecting units) installed on a ceiling 92; a laser pointer 11 (image-projecting unit) for outputting a nudge 60 (instruction mark) to be displayed on the floor 93; a monitoring camera 12 (imaging unit) that captures an image of an area where the nudge 60 will be displayed; an output-control unit 22 for controlling the output of the nudge 60; and a person-movement-determining unit 26 (output-direction-determining unit) that, based on the image captured by the monitoring camera 12, determines an output direction in which to output the nudge 60; wherein the nudge 60 that is outputted from the laser pointer 11 is reflected by a curved mirror and displayed at a nudge-display position P1.

With this configuration, an image reflected by the curved mirror 50 can be projected onto the floor 93 from above. In other words, when displaying a nudge 60, it is possible to avoid obstruction of the display by obstacles.

(2) The person-movement-determining unit 26 determines, based on the image captured by the monitoring camera 12, an optical path PO in which there is no obstacle in the path through which the nudge 60 passes as the output direction.

As a result, when displaying a nudge 60, it is possible to further avoid obstruction of the display by obstacles.

(3) The person-movement-determining unit 26 sets the priority for selecting an optical path to high for an optical path PO that is close to vertical when projecting onto the floor 93.

With this kind of configuration, in the case where a plurality of optical paths PO can be selected for displaying one nudge 60, the influence of obstacles can be effectively eliminated by increasing the priority for the optical path PO that is nearly vertical. An obstacle is, for example, a person P2 or another object.

(4) The person-movement-determining unit 26, when displaying a nudge 60, removes the nudge 60 in the case where a person P2 blocks any of the optical paths PO.

As a result, performing wasteful displays can be avoided, and discomfort given to the person P2 can be avoided.

The present disclosure has been explained above based on an embodiment. It is to be understood by those skilled in the art that this embodiment is only an example, and that various modifications are possible for combinations of the respective components and that such modifications are also within the scope of the present disclosure. For example, a curved mirror 50 is given as an example of a reflecting unit, however the present invention is not limited to this and a flat mirror may be used. Moreover, it is also possible to change the orientation of the reflecting unit, and control that orientation according to the movement of the person P2.

In the typical technique described above, in the case of causing a projecting apparatus to display walking instructions on a floor, there are cases where the pedestrians themselves and other obstacles (blocking objects) are not taken into consideration and the walking instructions cannot be appropriately displayed when the walking instruction is displayed, so another technique has been desired.

According to the present disclosure, in the case of causing instruction marks to be displayed on a floor, it is possible to achieve a technique for appropriately displaying the instructions while taking into consideration people and other obstacles (shielding objects).

What is claimed is:

1. A display system comprising:
a plurality of reflecting units installed on a ceiling;
an image-projecting unit that outputs an instruction mark to be displayed on a floor;
an imaging unit that captures an image of an area where the instruction mark is displayed;
an output-control unit that controls the output of the instruction mark; and
an output-direction-determining unit that, based on an image captured by the imaging unit, determines an output direction in which to output the instruction mark; wherein
the instruction mark that is outputted from the image-projecting unit is reflected by the reflecting unit and displayed at a mark-display position.

2. The display system according to claim 1, wherein
the output-direction-determining unit determines, based on the image captured by the imaging unit, an optical path in which there is no obstacle in the path through which the instruction mark passes as the output direction.

3. The display system according to claim 1, wherein
the output-direction-determining unit sets a priority for selecting an optical path to high for an optical path that is close to vertical when projecting onto the floor.

4. The display system according to claim 1, wherein
the output-direction-determining unit, when displaying an instruction mark, removes the instruction mark in the case where a person blocks any of the optical paths.
